(19) United States
(12) Patent Application Publication
(10) Pub. No.: US 2007/0233448 A1
(43) Pub. Date: Oct. 4, 2007

(54) Detecting computer system simulation errors

(75) Inventors: Efstathios Papaefstathiou, Redmond, WA (US); John M. Oslake, Seattle, WA (US); Jonathan C. Hardwick, Kirkland, WA (US); Pavel A. Dournov, Redmond, WA (US); Rohit R. Naik, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/394,945

(22) Filed: Mar. 31, 2006

(51) Int. Cl. G06F 17/10; G06F 17/50

(52) U.S. Cl. 703/15; 703/2

(57) ABSTRACT

Validating simulation models. A computing environment includes a performance scenario of a system. The performance scenario includes device models defining device behavior and/or capacity. The performance scenario further includes interconnections between one or more device models. A static model analysis of the system is performed. The static model analysis analyzes at least one of configuration of device models defined by the performance scenario or interconnection of device models defined by the performance scenario. A static capacity analysis to analyze device model limitations as they relate to statically defined performance scenario characteristics is performed. An application constraints validation can be performed. This includes comparing the performance scenario to software deployment best practices and rules related to models similar to the performance scenario. A simulation runtime validation may also be performed to evaluate dynamic device usage and latencies to simulate the system.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Computer systems can be interconnected in large network configurations so as to provide additional functionality. For example, one typical network configuration is a configuration of computer systems interconnected to perform e-mail functionality. In one particular example, an e-mail server acts as a central location where users can send and retrieve emails. For example, a user may send an e-mail to the e-mail server with instructions to the e-mail server to deliver the message to another user connected to the e-mail server. Users can also connect to the e-mail server to retrieve messages that have been sent to them. Many e-mail servers are integrated into larger frameworks to provide functionality for performing scheduling, notes, tasks, and other activities.

Each of the computer systems within a network environment has certain hardware limitations. For example, network cards that are used to communicate between computer systems have a limited amount of bandwidth meaning that communications can only take place at or below a predetermined threshold rate. Computer processors can only process a given amount of instructions in a given time period. Hard disk drives are limited in the amount of data that can be stored on the disk drive as well as limited in the speed at which the hard disk drives can store the data.

When creating a network that includes a number of different computer systems it may be desirable to evaluate the selected computer systems before they are actually implemented in the network environment. By evaluating the systems prior to actually implementing them in the network environment, trouble spots can be identified and corrected. This can result in a substantial cost savings as systems that unduly impede performance can be upgraded or can be excluded from a network configuration.

When simulating complex computing systems, a significant amount of effort is required to build the model and to ensure that the model includes appropriate interconnections between model devices. For example, if a server environment is being simulated, it is important to ensure that clients are also being simulated so as to provide appropriate modeled network traffic and requested loads for the server environment.

Additionally, because of the complexities of some simulations, it may be likely that a significant number of errors may be generated during the simulation. These errors are often eliminated iteratively. For example, a simulation is run and errors are returned. Corrections are then made and the simulation run again, which may produce the same or other errors. Additional corrections may be performed and simulations run until all errors are eliminated or at a sufficiently low level to be ignored.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes computer readable media implemented in a computing environment. The computing environment includes a performance scenario of a system. The performance scenario includes device models defining device behavior and/or capacity. The performance scenario further includes interconnections between one or more device models. The computer readable media includes computer executable instructions configured to perform a static model analysis of the system. The static model analysis analyzes at least one of configuration of device models defined by the performance scenario or interconnection of device models defined by the performance scenario. The computer readable media is further configured to perform a static capacity analysis to analyze device model limitations as they relate to statically defined performance scenario characteristics. An application constraints validation can be performed. This includes comparing the performance scenario to software deployment best practices and rules related to models similar to the performance scenario.

Another embodiment described herein includes computer readable media implemented in a computing system. The computing system is configured to perform modeling functions for modeling complex systems to detect system capacities and capabilities. The computer readable medium includes data structures and computer executable instructions for facilitating modeling of complex systems. The computer readable medium includes a first data structure including one or more device models defining device behavior and/or capacity organized into a performance scenario connecting device models together to model a system. The computer readable media further includes computer executable instructions for performing a application constraints validation including comparing the performance scenario to software deployment best practices and rules and providing indications when the software deployment best practices and rules dictates against the configuration of the performance scenario.

Another embodiment includes a method that may be performed in a computing environment. The computing environment includes a performance scenario of a system. The performance scenario includes device models defining device behavior and/or capacity. The performance scenario further includes interconnections between one or more device models. The method includes detecting an error associated with a device model during a simulation runtime validation of the device. The device model is modified during the simulation runtime validation to obviate the error such that other device models can continue to be evaluated in the context of the performance scenario.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a performance scenario for simulation;

FIG. 2 illustrates validation stages applied to the performance scenario;

FIG. 3 illustrates an example of a static model analysis;

FIG. 4 illustrates an edge labeled directed graph modeling a transaction;

FIG. 5 illustrates a method of evaluating a system; and

FIG. 6 illustrates another method of evaluating a system.

### DETAILED DESCRIPTION

Embodiments herein may comprise a special purpose or general-purpose computer including various computer hardware, as discussed in greater detail below.

In one embodiment, a simulation is performed in stages. For example, the simulation may include a static model analysis stage, a static capacity analysis stage, and application constraints validation stage, and a runtime validation stage.

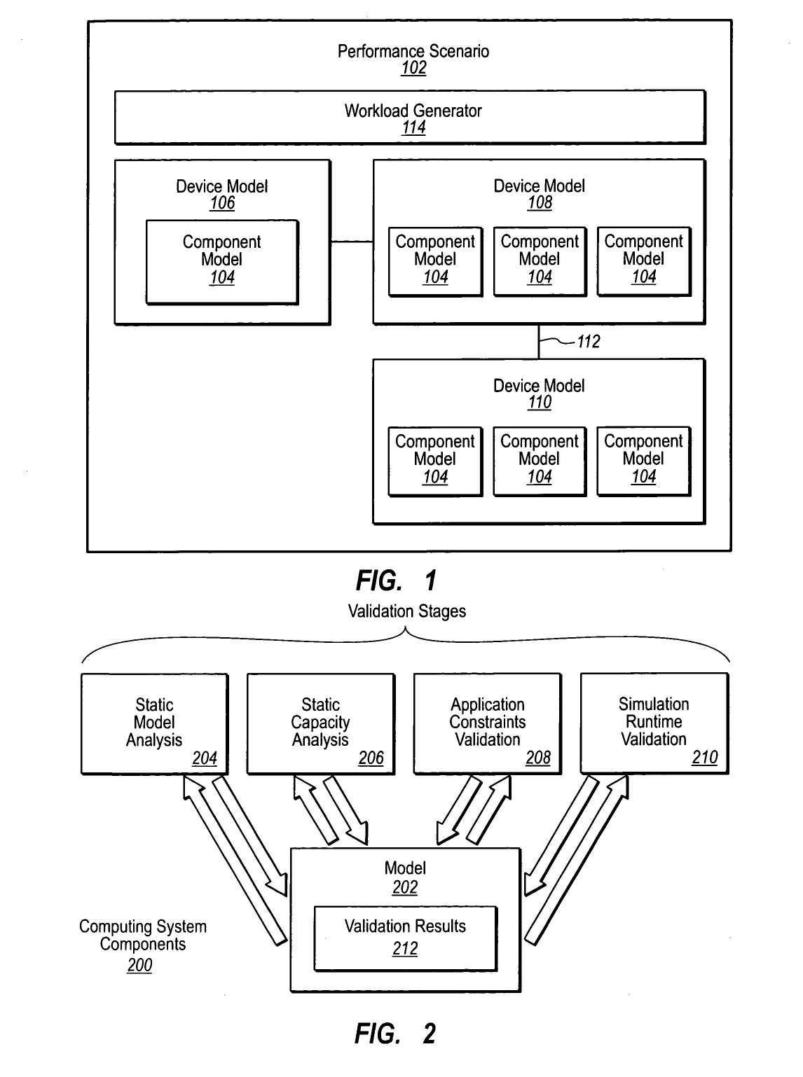

Referring now to FIG. 1, a performance scenario 102 is illustrated. The performance scenario 102 may include a model of a computing system including device models 104, 106, 108, 110. As illustrated, device models may be connected in a fashion to simulate the computing system. The performance scenario 102 may specify device models are interconnected with one another. For example, the performance scenario 102 may specify servers interconnected with clients. For example, the device model 108 may represent a server model where as the model 110 may represent a client model. An interconnection 112 may be specified in the performance scenario 102 connecting the server model 108 to the client model 110. Additionally, the performance scenario 102 may specify individual devices within a computer system. For example, the performance scenario 102 may specify for a computer system devices such as processors, network connections, storage, memory and so forth. Illustratively, FIG. 1 illustrates that device model 104 is specified as a component of device model 106.

The performance scenario 102 may be used, in one exemplary embodiment to evaluate complex computer systems to determine expected utilization of devices in the computer system and latencies for transactions performed within the computer system. This may be used to determine the stability of the complex computer system, capacity of the complex computer system, speed of the complex computer system, and the like. The performance scenario 102, therefore includes a workload generator 114. The workload generator 114 produces activities to be simulated by the device models. For example, if the device model 104 is a model of a hard drive, the workload generator 114 may produce disk I/O actions, such as reads and writes, that are to be performed by the device model.

Additionally, some device models may be configured as producers of workload. For example, a client device model may be configured to request certain transactions. In one embodiment, the device model may be configured to request transactions at a certain rate which may be defined, for example, as transactions per second. Illustratively, a client model may be designed to issue a get mail transaction at a rate of 12 times per second. Alternatively, a client model may be configured to request transactions in a saturation mode, which is a mode that generates transactions as a function of device model utilization. For example, the client model may be designed to generate request mail transactions at a rate that is 25% of the processor model usage for the processor model included in the client model.

The workload generator 114 is responsible for creating the transactions specified and assigning all or part of the transaction to certain device models for simulation. The get mail transaction may involve various actions being simulated by various device models such as cpu cycles, disk I/O actions and network transmissions.

Various validations are performed on the model for various purposes. The example shown in FIG. 2 shows four validation stages including a static model analysis stage 204, a static capacity analysis stage 206, an application constraints validation stage 208, and a simulation runtime validation stage 210. These validation stages perform various functions as will be described in more detail below but including functions such as ensuring that the model 202 has been appropriately constructed, ensuring the devices selected in the model have appropriate capacity for the selected application, ensuring that the model meets general criteria specified in the software deployment best practices and rules related to computing systems being modeled by the model 202, and evaluating the model 202 in a runtime environment to determine expected behavior of the computing system modeled by the model 202.

FIG. 2 further illustrates a validation results 212. In the embodiment shown in FIG. 2, each of the validation stages may supply information to the validation results 212 such that the validation results 212 becomes a part of the model 202. Each of the validation stages discussed above will now be discussed in more detail to further illustrate the functionality of the validation stages.

Static Model Analysis

FIG. 2 illustrates a static model analysis 204. The static model analysis can be used to verify the model 202 against a series of conditions that are independent from an application being modeled by the model 202. For example, if the model 202 is modeling a mail server environment, the static model analysis 204 is able to verify conditions that are not dependent on the fact that the application being modeled by the model 202 is a mail server environment.

The static model analysis stage 204 may be used to verify various interconnections and presence of system constraints. For example, the model 202 may model an enterprise network. Typically, an enterprise network is a wide area network (WAN) with a number of interconnected sites. The sites each typically include servers and clients as well as connectivity to other sites within the enterprise network. The sites may be distributed throughout an enterprise where the distribution of sites may include distributing the sites throughout a building, throughout a city, throughout a state, or worldwide. The static model analysis 204 may validate various constraints for the interconnection of the sites or for the sites themselves.

For example, the static model analysis may validate that each site instantiated in the model 202 has computer systems at the site. If computer systems do not exist at the site, it is likely an error because the site will not be able to generate or accept data requests. As such, the simulation of the model 202 will not produce results indicating the type of hardware loading that will occur because of the site in the model 202. The static model analysis 204 may verify that a site has a particular type of computer system. For example, the static model analysis 204 may verify that servers and/or clients exist at a site.

The static model analysis 204 may further include functionality for verifying that servers have clients and clients have servers. If no clients are specified for a server in the model 202, no request load will be detected and thus the server cannot be appropriately evaluated. If clients are not connected to servers, it is likely that a particular client load has been specified that will not be accounted for by a runtime analysis of the model 202.

As alluded to previously, the static model analysis 204 can further detect the lack of connections or improper connections between devices specified in the model 202. Additionally, the static model analysis 204 may be able to detect improper service mapping or the lack of service mapping whatsoever.

The static model analysis 204 can further detect when devices in the model have not been configured. A user may construct a model 202 including various devices modeled as device models. If the user neglects to configure one or more of the device models, the static model analysis can detect this situation and alert the user through error reporting. Similarly, the static model analysis may detect for device models modeling networks, that there are no disconnected termination points.

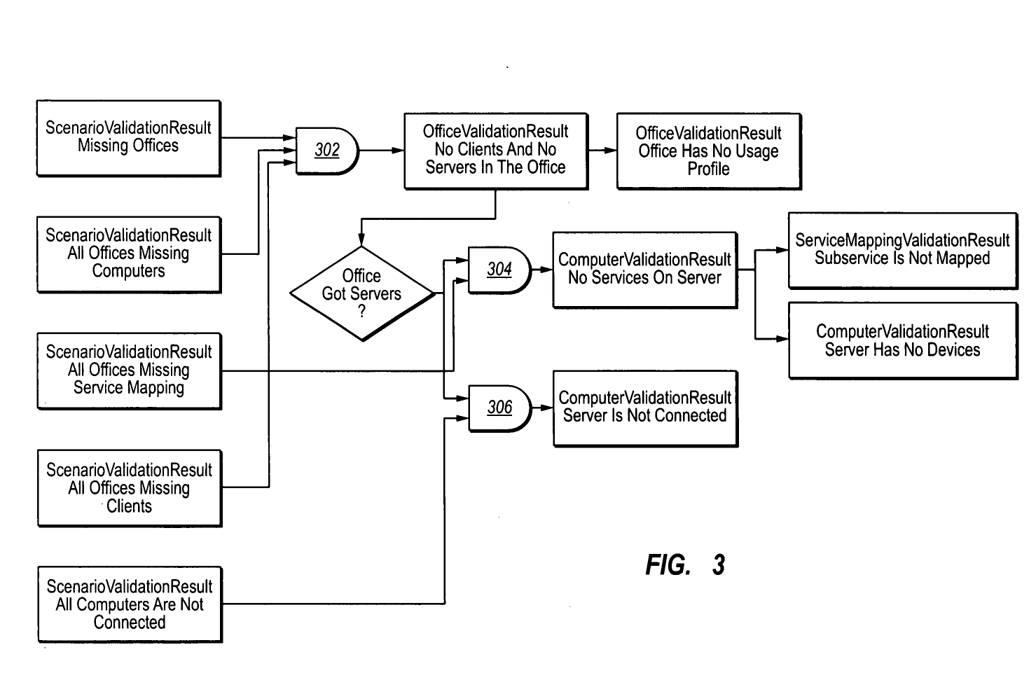

To minimize the number of errors generated in the static model analysis 204, some embodiments may be organized such that some conditions do not get validated if higher level conditions result in errors. This may be accomplished in one embodiment by performing the static model analysis 204 in a logically bounded sequence graph. Such a graph is illustrated in FIG. 3. FIG. 3 illustrates logical devices in the form of AND gates that illustrate logical conditions to be evaluated prior to lower level conditions being evaluated. For example, the AND gate 302 requires that the model 202 not have missing offices, missing computers in offices, and missing clients in offices. The AND gate 304 requires the validation of servers and service mapping. The AND gate 306 requires the validation of servers and computer connections. If these condition fail then a validation engine reports an error that indicates that the office is missing servers or clients. If either servers or clients are present, the validation engine continues verification to verify whether the office has a usage profile that configures the application models deployed in the office. This way the usage profile is checked only if the office can have any applications deployed.

Static Capacity Analysis

Referring once again to FIG. 2 a static capacity analysis 206 is shown. The static capacity analysis 206 can be used to verify that hardware devices are configured in the model 202 with sufficient capacity to accommodate the loads described in the model 202. In the embodiment shown in FIG. 1, the static capacity analysis 206 verifies capacity for device characteristics that do not require simulation of the model 202 to compute the capacity. The static capacity analysis may evaluate conditions such as storage size, processor speed, memory size, and the like. As an example, the capacity demand for a storage device size such as a hard drive can be determined by using computations based on usage parameters. For example, in a mailbox server scenario, the amount of storage needed at a mail server can be calculated based on the number of users, the mailbox size for each of the users, and an overhead factor. The static capacity analysis 206 can determine that the required storage size is more than the size provided by the device configuration such that a validation error can be generated. The validation error can provide an estimate of the required storage size so that resolution of the error can be more efficiently achieved.

Application Constraints Validation

FIG. 2 also illustrates an application constraints validation 208. The application constraints validation 208 is able to verify that specific requirements for a specific application are met. For example, when an operations manager application is verified by the application constraints validation 208, a rule may exist that no more than one database server can be deployed per operations manager management group. Thus, the application constraints validation 208 may verify that the model 202 when used in an operations manager application does not include more than one database server per operations manager management group

The application constraints validation 208 may include verification of best practices and other deployment rules that can be used to verify a model 202. This feature is particularly useful as it can be used to eliminate the need for experts in an area of system design to create and perform validation on the model 202. In particular, the application constraints validation 208 including software deployment best practices and rules provides a sort of “expert in the box” to ensure that applications are designed according to software deployment best practices and rules at the time the application is to be implemented.

These software deployment best practices and rules are typically published in application deployment instructions as a set of rules and restrictions that someone installing the application should follow. Software deployment best practices and rules can include both numeric limits and relational constraints. Sample numeric limits include the maximum number of devices supported by an application, minimum hardware requirements, and the maximum number of users. Sample relational constraints include whether two components of a distributed application can be installed on the same computer, on two computers in the same office connected by a local-area network, and/or on two computers in different offices separated by a wide-area network link

Additionally, in one embodiment, the application constraints validation 208 may be extensible such that newly discovered software deployment best practices and rules can be added to the application constraints validation. Thus, as new techniques and information are developed about implementing applications, the new techniques and information can become part of the overall validation process by being included in the application constraints validation 208. This may be accomplished in one embodiment by the software deployment best practices and rules being stored in rule files. Additional rule files can be added to add additional software deployment best practices and rules to the application constraints validation By using rule files or similar technology, when new software deployment best practices and rules is added, there is no need to recompile all or part of a simulation application that makes use of the software deployment best practices and rules. Rather, the application can simply reference any new rule files or changes to rule files to take into account new software deployment best practices and rules.

Simulation Runtime Validation

Due to nonlinear effects on the devices under mixed load and complex workload scheduling procedures some errors in the model 202 are best detected by event based simulation. One embodiment simulates models 202 to compute detailed utilization for devices defined in the model. Additionally, latency for transactions generated by the modeled applications can be calculated. Examples of transactions include, but are not limited to, sending emails, retrieving emails, storing and retrieving database items, requesting data from a server, and the like.

One embodiment described herein allows errors in the model 202 to be isolated such that the simulation runtime validation can be continued to discover other errors without the need for the user to manually correct the error and run the simulation runtime validation again. One example of an error that may be isolated relates to detection of overloaded devices. A device is overloaded when the rate of incoming requests is greater than the service rate. In other words, new requests come in more often than processed requests come out when the system is at a settled state. The usual result of simulation of an overloaded device is a constantly growing queue of the incoming requests. Normally the simulation cannot be continued as the queue will eventually take all available memory on the computer that runs the simulation. In one embodiment, when an overloaded device is detected, the device can be “short circuited” such that requests can propagate to other devices in the model 202. In one embodiment, short circuiting a device includes reconfiguring the device to have an infinite capacity or by assigning the device a latency of zero. As such, no matter how many requests are directed at the overloaded device, the device will be able to service all requests. An error for the particular overloaded device will nonetheless be reported, but by short circuiting the device, other simulation runtime validation 210 errors can be detected without the need to halt the simulation runtime validation 210, correct the overloaded device, and perform the simulation runtime validation 210 again.

Illustrating now a more detailed explanation of one procedure for isolating an overloaded device, an overloaded device is detected by the simulation runtime validation 210 by monitoring simulation statistics. An overloaded device in one embodiment, is one in which the utilization is stable but is above an over utilization threshold. A notification that the device is over utilized is propagated to a simulation controller. The simulation controller short-circuits the overloaded device making its latency time zero. In effect, this configures the device to have an infinite throughput capacity. The simulation controller marks the device as short-circuited so that the device model can adjust its algorithms. The simulation controller marks all the transactions in the backlog that were blocked by the overloaded device as cancelled. These transactions are removed from the system so as to prevent devices downstream from the overloaded device from being overwhelmed by the cached transactions when the overloaded device is short-circuited.

Once the overloaded device is short-circuited the simulation runtime validation 210 can continue such that additional errors can be detected.

In one embodiment, short circuiting overloaded devices is only used if the transactions are generated in a mode where the rate of transactions is set as transactions per second and not as a function of the device utilization. If the transactions are injected into the system with the rate that is a function of the device utilization, applying this method may result in altered transaction rate which will then lead to incorrect simulation results. In one embodiment, the simulation controller does not apply this method if at least one transaction class is configured to start transactions not in the transaction per second mode.

The simulation runtime validation may further be able to detect routing errors and other model 202 mis-configurations. For example, the model 202 may include information about application service deployment over a hardware topology. The model can require that an application service instance be able to exchange messages with another application service. As such, these two interacting services should be deployed on connected computers. If this condition is not met then the model 202 will not be able to generate transactions of certain types. In one embodiment, transactions that experience a critical error that would normally halt the simulation runtime validation 210 are disabled. The simulation runtime validation is then continued with the rest of the transactions.

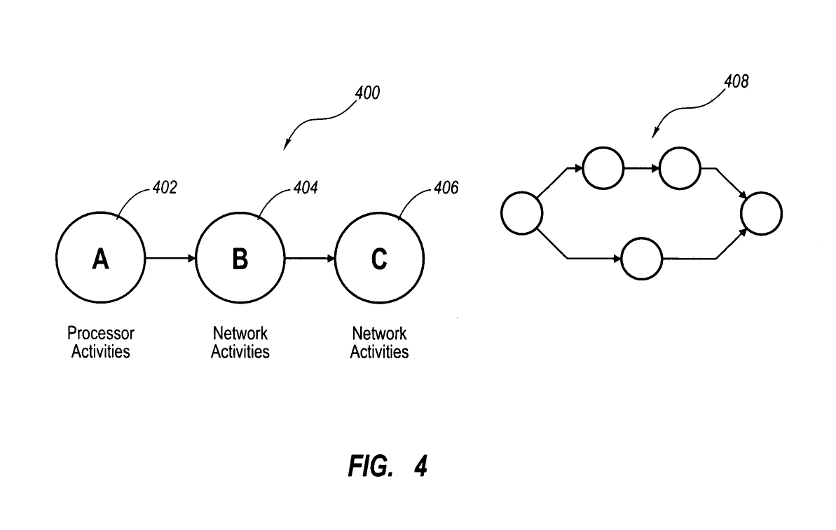

The following represent a more detailed description of how this is accomplished. A transaction generation device detects an error during generation of a transaction graph. In this example, a transaction graph is an edge labeled directed graph that divides a transaction into individual actions. For example, a request mail transaction may be represented using an edge labeled directed graph, such as the edge labeled directed graph 400 shown in FIG. 4. At a first node 402 a number of processor actions are simulated at a client model representing processor activities for generating a request to retrieve mail. At a second node 404, network activities are simulated at the client model representing network activities at the client for sending a request from the client to a server to retrieve mail. At a third node 406, network actions are simulated simulating receiving the request for mail at a server computer model. If no connection exists between the client model processing the network activities represented by 404 and the server model processing the network activities represented by 406, an error will be generated. An alternate edge labeled directed graph 408 is also shown in FIG. 4. The alternate edge labeled directed graph illustrates that a transaction may include actions that are performed in parallel such that actions can be performed at the same time. If actions are mapped sequentially, a first action is completed before beginning the next action.

When a transaction generation device detects an error during generation of a transaction graph, the transaction generator reports the error to the model 202. The model 202 may store the error in the validation results 212. The transaction generator may remove the transaction class that failed from a queue of transactions so that this transaction class will not be invoked by the transaction generator again. The simulation continues.

Because all the transactions will be simulated, the simulation results cannot be presented to the user. This method is only intended for not stopping the simulation and for collecting all such errors in the system in one simulation run.

Error Reporting and Validation Results

When errors are discovered, the errors are reported to the user. Two error classes that may be reported to the user are model configuration warnings and model critical errors. Model configuration warnings identify situations when the model is not properly configured but it is still possible to run the simulation and produce meaningful simulation results. Model critical errors identify situations when a problem exists with the model that prevents the simulation engine from producing meaningful results. When model critical errors result, simulation results are typically not displayed. The user may need to fix critical errors and re-run the validations to obtain simulation results.

In one embodiment, the errors may be included in the validation results 212 (FIG. 2) which becomes part of the model 202. The validation results 212 may be in an XML format. This allows the validation results 212 to include errors and results from various validation tools and further allows the validation results to be extensible to include results from new tools when they become available.

Errors may be instantiated in the validation results 212 such that they can quickly be associated with a device model or interconnection between device models. In one embodiment, a graphical user interface can provide the user with a list of errors and allow the user to select an error. When the error is selected, the graphical user interface can highlight a representation of the device model or connection that caused or is affected by the error.

When the list of errors is generated by the chain of validation tools that include: the validation engine for static model analysis, the simulation engine for runtime analysis, the application models for static application specific analysis, the user is provided with a list of errors. Each error in the list has an indication whether this is a critical error or warning, and provides a link to the most likely model element that needs to be changed to fix the problem.

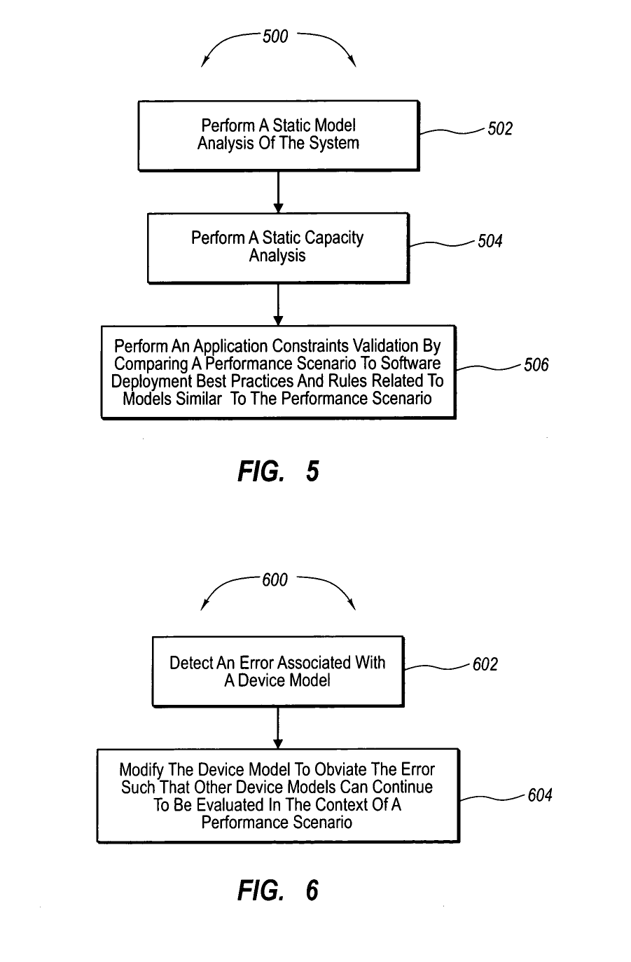

Referring now to FIG. 5, a method of evaluating a system is illustrated. The method may be practiced, for example, in a computing environment, including a performance scenario of a system. The performance scenario includes device models defining device behavior and/or capacity. The performance scenario also includes interconnections between one or more device models. The method includes performing a static model analysis of the system (act 502). The static model analysis analyzes at least one of configuration of device models defined by the performance scenario or interconnection of device models defined by the performance scenario.

Performing a static model analysis may include evaluating the presence or absence of expected device models based on included device models. For example, if server device models are included, an analysis may be performed to determine if client device models are included.

Performing a static model analysis may include evaluating one or more higher level conditions and not evaluating one or more lower level conditions. This may be dependent on the higher level conditions when an error results from evaluating the one or more higher level conditions. Examples of this behavior are illustrated above in conjunction with the description of FIG. 3. Similarly, performing a static model analysis may include returning an error for one or more higher level conditions and not returning an error for one or more lower level conditions dependent on the higher level conditions when an error results from evaluating the one or more higher level conditions.

The method 500 further includes performing a static capacity analysis (act 504). The static capacity analysis is performed to analyze device model limitations as they relate to statically defined performance scenario characteristics.

Performing a static capacity analysis may include evaluating if capacity of a device model in the performance scenario is exceeded. As described above, certain capacities can be evaluated statically without the need to perform dynamic testing of the system. The example illustrated above includes the ability to calculate storage size for email clients given the number of clients, size of mailbox and an overhead factor.

The method 500 further includes performing an application constraints validation by comparing the performance scenario to software deployment best practices and rules related to models similar to the performance scenario (act 506).

Performing an applications constraint validation may include evaluating if the existence of a device model in the performance scenario does not conflict with the existence of another device model in the performance scenario. As described above, one example of this occur when an application requires only one server or database

As alluded to previously, performing an application constraints validation may include referencing rule files. Specifically, rule files may be used to store constraint rules. In one embodiment, this allows a simulation application to be updated with new functionality without requiring the simulation application to be recompiled.

The method 500 may further include performing a simulation runtime evaluation of the performance scenario by simulating one or more loads on one or more device models as dictated by loads generated by other device models in the performance scenario. As describe previously, device models may specify a number of transactions to be generated. Such transactions may include items such as requesting mail. The transactions may be divided into actions that can be simulated by device models.

Performing a simulation runtime evaluation of the performance scenario may include detecting that a device model has insufficient capacity and modifying the device model with insufficient capacity to have infinite capacity such that other device models can continue to be evaluated in the context of the performance scenario.

The method 500 may further include detecting routing errors and disabling generating transactions for a class of transactions affected by the routing errors. This allows analysis and validation to continue such that other errors can be detected without the need to stop the simulation, correct the routing errors and re-run the simulation.

Referring now to FIG. 6, another method is illustrated. The method may be practiced, for example, in a computing environment, including a performance scenario of a system. The performance scenario includes device models defining device behavior and/or capacity. The performance scenario further includes interconnections between one or more device models. The method includes detecting an error associated with a device model during a simulation runtime validation of the device (act 602). The method further includes modifying the device model during the simulation runtime validation to obviate the error such that other device models can continue to be evaluated in the context of the performance scenario (act 604).

Detecting an error may include detecting that a device model has insufficient capacity. In this case modifying the device model may include configuring the device model to have infinite capacity. In one embodiment, the method 600 includes canceling transactions in a backlogged queue so as to prevent the transactions from overwhelming downstream device models when the device model is configured to have infinite capacity.

Detecting an error may include detecting that a device model has one or more routing errors. In this case modifying the device model to obviate the error may include removing a transaction class affected by the routing error from a queue of transactions to be processed by the device model.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, including a performance scenario of a system, the performance scenario including device models defining device behavior and/or capacity, the performance scenario further including interconnections between one or more device models, computer readable media including computer executable instructions configured to:
perform a static model analysis of the system, wherein the static model analysis analyzes at least one of configuration of device models defined by the performance scenario or interconnection of device models defined by the performance scenario;
perform a static capacity analysis to analyze device model limitations as they relate to statically defined performance scenario characteristics; and
perform an application constraints validation comprising comparing the performance scenario to software deployment best practices and rules related to models similar to the performance scenario.

2. The computer readable media of claim 1, wherein the computer executable instructions are further configured to perform a simulation based runtime evaluation of the performance scenario by simulating one or more loads on one or more device models as dictated by the application component n the performance scenario.

3. The computer readable media of claim 2, wherein performing a simulation runtime evaluation of the performance scenario comprises:
detecting that a device model has insufficient capacity; and
modifying the device model with insufficient capacity to have infinite capacity such that other device models can continue to be evaluated in the context of the performance scenario.

4. The computer readable media of claim 1, wherein the computer executable instructions are further configured to detect errors that are related to misconfigured communication routs and/or connections in the performance scenario and disable generating transactions for a class of transactions affected by the routing errors.

5. The computer readable media of claim 1, wherein performing a static model analysis comprises evaluating expected inputs to one or more device models.

6. The computer readable media of claim 1, wherein performing a static model analysis comprises evaluating the presence or absence of expected device models based on included device models.

7. The computer readable media of claim 1, wherein performing a static model analysis comprises evaluating one or more higher level conditions and not evaluating one or more lower level conditions dependent on the higher level conditions when an error results from evaluating the one or more higher level conditions.

8. The computer readable media of claim 1, wherein performing a static model analysis comprises returning an error for one or more higher level conditions and not returning an error for one or more lower level conditions dependent on the higher level conditions when an error results from evaluating the one or more higher level conditions.

9. The computer readable media of claim 1, wherein performing an application constraints validation comprises evaluating if the existence of a device model in the performance scenario does not conflict with the existence of another device model in the performance scenario.

10. The computer readable media of claim 1, wherein performing a static capacity analysis comprises evaluating if capacity of a device model in the performance scenario is exceeded.

11. The computer readable media of claim 1, wherein performing an application constraints validation comprises referencing rule files.

12. The computer readable media of claim 1, further comprising a validation results data structure including results generated from the static model structure analysis of the system, the static capacity analysis, and the validation of other constraints referenced by the performance scenario.

13. The computer readable media of claim 12, wherein the validation results data structure comprises XML.

14. In a computing system configured to perform modeling functions for modeling complex systems to detect system capacities and capabilities, a computer readable medium comprising data structures and computer executable instructions for facilitating modeling of complex systems, the computer readable medium comprising:
a first data structure comprising one or more device models defining device behavior and/or capacity organized into a performance scenario connecting device models together to model a system; and
computer executable instructions for performing an application constraints validation including comparing the performance scenario to the application deployment and configuration best practices and providing indications when the best practices dictate against the configuration of the performance scenario.

15. The computer readable medium of claim 14, further comprising a second data structure comprising one or more rule files including the software deployment best practices and rules.

16. The computer readable medium of claim 15, wherein the rule files are extensible such that additional software deployment best practices and rules can be added.

17. In a computing environment, including a performance scenario of a system, the performance scenario including device models defining device behavior and/or capacity, the performance scenario further including interconnections between one or more device models, a method of evaluating the system, the method comprising:
detecting an error associated with a device model during a simulation runtime validation of the device; and
modifying the device model during the simulation runtime validation to obviate the error such that other device models can continue to be evaluated in the context of the performance scenario.

18. The method of claim 17, wherein detecting an error comprises detecting that a device model has insufficient capacity and modifying the device model comprises configuring the device model to have infinite capacity.

19. The method of claim 18, further comprising canceling transactions in a backlogged queue so as to prevent the transactions from overwhelming downstream device models when the device model is configured to have infinite capacity.

20. The method of claim 17, wherein detecting an error comprises detecting that a performance scenario has one or more misconfigured communication routes or connection errors and wherein modifying the device model to obviate the error comprises removing a transaction class affected by the routing error from a queue of transactions to be processed by the device model and disabling any further generation of transaction instances from this transaction class until the end of simulation.
